(19) United States
(12) Patent Application Publication
(10) Pub. No.: US 2018/0096469 A1
(43) Pub. Date: Apr. 5, 2018

(54) FRINGE DETECTION AND MITIGATION BASED ON HHT2-FRINGE ANALYSIS AND SYNTHESIS

(71) Applicant: U.S.A. as represented by the Administrator of the National Aeronautics and Space Administration, Washington, DC (US)

(72) Inventors: SEMION KIZHNER, Reisterstown, MD (US); Ron Shiri, Glyndon, MD (US)

(21) Appl. No.: 15/281,313

(22) Filed: Sep. 30, 2016

(51) Int. Cl. G06T 5/10; G06T 5/00; G06T 5/20; G02B 23/12; G06T 7/40

(52) U.S. Cl. CPC G06T 5/10; G06T 5/002; G06T 2207/20182; G02B 23/12; G06T 7/408; G06T 5/20

(57) ABSTRACT

Various embodiments relate to an apparatus, method and a non-transitory computer readable medium for fringe detection and mitigation in an image using Hilbert-Huang Transform (“HHT2-Fringe”) configured to apply Empirical Mode Decomposition (“EMD2”) to a measured light intensity suppression to generate bi-dimensional intrinsic mode functions (“BIMFs”), apply Hilbert Spectral Analysis (“HSA2”) to analyze a plurality of outer fringe bright bands of the BIMFs, propagating the amplitudes of the plurality of outer fringe bright bands of the BIMFs into the center of the image using linear approximation, determine fringe magnitudes of the BIMFs, adding the magnitudes of the BIMFs and subtracting the difference from magnitudes of a petal area of the image.

### ORIGIN OF THE INVENTION

This invention described herein was made by an employee of the United States Government, and may be manufactured and used by or for the Government for Government purposes without the payment of any royalties thereon or therefore.

### TECHNICAL FIELD

This disclosure relates generally to a data processing system for fringe interference detection and mitigation, and more specifically, but not exclusively, to utilizing a combination of a two-dimensional (“2-D”) Empirical Model Decomposition (“EMD2”) and the Hilbert Spectral Analysis (“HSA2”) resulting in the 2-D Hilbert Huang Transform (“HHT2”) to detect and mitigate interference fringes.

### RELATED APPLICATIONS

U.S. Pat. No. 9,013,490 describes a Hilbert-Huang transform data processing real-time system with 2-D capabilities which is hereby incorporated by reference for all purposes as if fully set forth herein.

### BACKGROUND

Optical filters are used to selectively transmit through or reject a wavelength of light or range of wavelengths and reduce light intensity. Light intensity suppression optical filter masks are a common optical component used in optical instruments.

For example, when an image is taken with a telescope using a neutral optical filter that is suppressing 95% of solar light or an H-Alpha filter (i.e., for solar viewing), there is a need to further suppress starlight by orders of magnitude better than the suppression achievable by the current state-of-the-art optical filter technologies. This is because the current state-of-the-art optical filters cannot detect fainter objects. The problem with state-of-the-art optical filters is that perfectly shaped heritage and state-of-the-art circular filter masks are plagued by unwanted interference fringes. The fringe interference and Poisson's Spot become a problem that requires a new solution.

### SUMMARY OF EXEMPLARY EMBODIMENTS

A brief summary of various embodiments is presented below. Embodiments address the need to detect and mitigate fringes based on HHT2 analysis and synthesis.

In order to overcome these and other shortcomings of the prior art and in light of the present need for a method to detect and mitigate fringes, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various embodiments described herein relate to a method for fringe detection and mitigation in an image using Hilbert-Huang Transform (“HHT2-Fringe”), the method including applying Empirical Mode Decomposition (“EMD2”) to a measured light intensity suppression to generate bi-dimensional intrinsic mode functions (“BIMFs”), applying Hilbert Spectral Analysis (“HSA2”) to analyze a plurality of outer fringe bright bands of the BIMFs, propagating the amplitudes of the plurality of outer fringe bright bands of the BIMFs into the center of the image using linear approximation, determining fringe magnitudes of the BIMFs, adding the magnitudes of the BIMFs and subtracting the difference from magnitudes of a petal area of the image.

In an embodiment of the present disclosure the method further comprises determining whether the difference between the magnitudes of the BIMFs and the magnitudes of the petal area of the image is approximately the difference between the measured light intensity suppression and a predicted light intensity suppression.

In an embodiment of the present disclosure BIMFs visualize qualitative behavior of base functions caused by amplitude quantitative content.

Various embodiments described herein relate to a non-transitory computer readable medium storing program code for fringe detection and mitigation in an image using Hilbert-Huang Transform (“HHT2-Fringe”), the program code being executable by a process to perform operations comprising applying Empirical Mode Decomposition (“EMD2”) to a measured light intensity suppression to generate bi-dimensional intrinsic mode functions (“BIMFs”), applying Hilbert Spectral Analysis (“HSA2”) to analyze a plurality of outer fringe bright bands of the BIMFs, propagating the amplitudes of the plurality of outer fringe bright bands of the BIMFs into the center of the image using linear approximation, determining fringe magnitudes of the BIMFs, adding the magnitudes of the BIMFs and subtracting the difference from magnitudes of a petal area of the image.

In an embodiment of the present disclosure the non-transitory computer readable medium further comprises determining whether the difference between the magnitudes of the BIMFs and the magnitudes of the petal area of the image is approximately the difference between the measured light intensity suppression and a predicted light intensity suppression.

In an embodiment of the present disclosure BIMFs visualize qualitative behavior of base functions caused by amplitude quantitative content.

Various embodiments described herein relate to a computing device for fringe detection and mitigation in an image using Hilbert-Huang Transform (“HHT2-Fringe”), comprising a processor, and a memory coupled to the processor and containing instructions that, when executed by the processor, perform a set of functions including applying Empirical Mode Decomposition (“EMD2”) to a measured light intensity suppression to generate bi-dimensional intrinsic mode functions (“BIMFs”), applying Hilbert Spectral Analysis (“HSA2”) to analyze a plurality of outer fringe bright bands of the BIMFs, propagating the amplitudes of the plurality of outer fringe bright bands of the BIMFs into the center of the image using linear approximation, determining fringe magnitudes of the BIMFs, adding the magnitudes of the BIMFs and subtracting the difference from magnitudes of a petal area of the image.

In an embodiment of the present disclosure the computing device, the memory further comprises instructions that when executed by the processor perform a set of functions including determining whether the difference between the magnitudes of the BIMFs and the magnitudes of the petal area of the image is approximately the difference between the measured light intensity suppression and a predicted light intensity suppression.

In an embodiment of the present disclosure BIMFs visualize qualitative behavior of base functions caused by amplitude quantitative content.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

These and other more detailed and specific features of the present invention are more fully disclosed in the following specification, reference being had to the accompanying drawings, in which:

FIG. 1 illustrates a circular mask image;

FIG. 2 illustrates a graph of the relative intensity of a 2-millimeter petal mask;

FIG. 3A illustrates an optics branch coronagraphy testbed sensor gray image;

FIG. 3B illustrates an optics branch coronagraphy testbed sensor synthetic color;

FIG. 4 illustrates a method for fringe detection and mitigation in an image using Hilbert-Huang Transform (“HHT2-Fringe”); and

FIG. 5 illustrates a block diagram of a real-time data processing system with 2-D capabilities, according to an embodiment of the present invention.

### DETAILED DESCRIPTION OF THE INVENTION

It should be understood that the figures are merely schematic and are not drawn to scale. It should also be understood that the same reference numerals are used throughout the figures to indicate the same or similar parts.

The descriptions and drawings illustrate the principles of various example embodiments. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. Descriptors such as “first,” “second,” “third,” etc., are not meant to limit the order of elements discussed, are used to distinguish one element from the next, and are generally interchangeable.

Furthermore, the problem with optical filters is that perfectly shaped heritage and state-of-the-art circular filter masks are plagued by unwanted interference fringes. The Siméon Poisson's Spot on a sensor at the mask's image center further plagues optical filters.

Even further, presently used fringe analysis uses linear based Fourier Transformation, which is inadequate due to the fringe phenomenon, which is of a non-linear and non-stationary nature in 2-D image processing. By using HHT2, fringe detection and mitigation and phase untangling can occur in near real-time.

The fringe phenomenon is caused by optical flat imperfections and other interferences in the glass substrate which are not presently taken into account in theoretical modeling (such as in mask materials). As discussed above, fringe patterns are ubiquitous in optical systems and are attributed to non-linearity in optical surfaces due to optical element materials and manufacturing, as well as operating environment effects (such as temperature, vacuum, etc.).

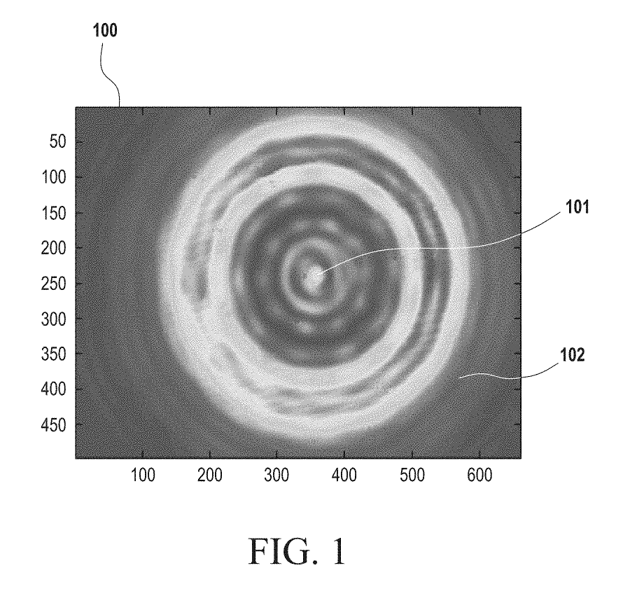

FIG. 1 illustrates the aforementioned circular mask image 100. When the circular mask is mounted on a glass substrate and illuminated by a collimated laser, interference fringes are present outside the mask 102 and Poisson's Spot 101 is present at the mask's center.

FIG. 1 also illustrates interference fringe effects (i.e., light streaks) in the completely opaque mask's shadow area. When mask suppression is required to be very substantial (i.e., as in exo-planet finding and star observation), the fringe interference outside the circular mask 102 and Poisson's Spot 101 become a problem.

The use of petal masks (replacing circular masks) have been used because the derivation of the finer order of the intensity suppression can be based on petal mask geometry (and on an assumption of perfect optical components), however, for the petal mask to work, it must be mounted on an on an optical glass flat with the glass substrate fully holding the petal mask plus a band around the mask boundary (e.g., a filter wheel) with the mask at the center of wheel. Adopting this approach, the glass substrate introduces undesirable fringe patterns in the mask shadow, however, the benefits are that its brightness is substantially reduced and the Poisson's Spot is eliminated.

Using a petal mask (as discussed above) with a collimated laser light source (i.e., parallel light waves) results in improved measured light intensity suppression (“Iₘ”) with the exception of a discrepancy δ problem by an order of magnitude from a theoretical prediction (“Iₚ”).

Therefore, there is a need to remove the interference fringes in a digital domain by applying a combination of 2-D EMD and HSA2, for analyzing the data from non-linear and non-stationary processes, as is present in 2-D image data.

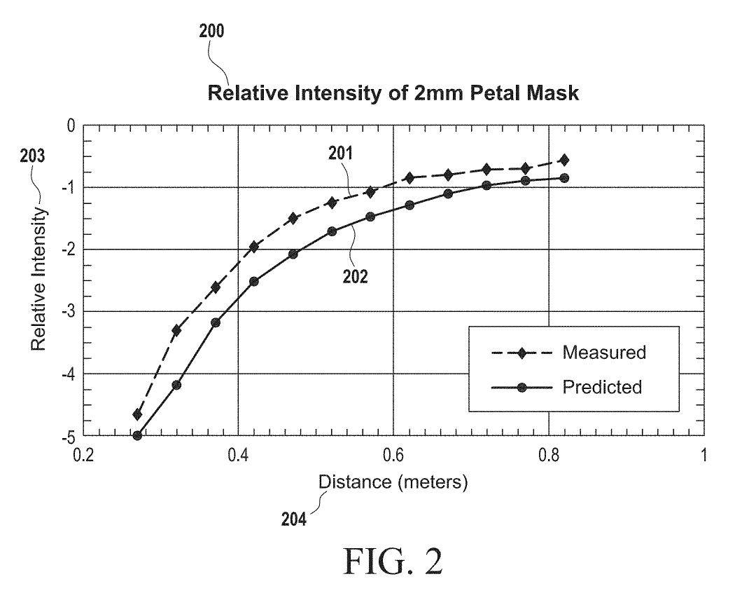

FIG. 2 is a graph 200 of the relative light intensity 203 of a two-millimeter petal mask over a distance 204. The Iₘ 201 is represented by a dotted line, and the Iₚ 202 is represented by a solid line 202.

The discrepancy δ problem is the maximum distance between the Iₘ 201 and the Iₚ 202: Iₘ−Iₚ=δ.

The discrepancy δ problem is attributed to fringe interference. The present state-of-the-art in fringe pattern detection mitigation is based on Fourier Transformation that is configured to detect and remove fundamental fringe phenomenology. Furthermore, the discrepancy δ problem is characterised by sign ambiguity problems, order ambiguity problems, noise problems, and phase discontinuity problems.

Application of a combination of 2-D EMD2 and HSA2 (i.e., HHT2-Fringe) solves the discrepancy δ problem by directly detecting event faint fringe spectra, by being an optical mask only to spectra's residual interference, by detecting fringes in the mask's shadow, by detecting noise as a first component and by unwrapping the phases.

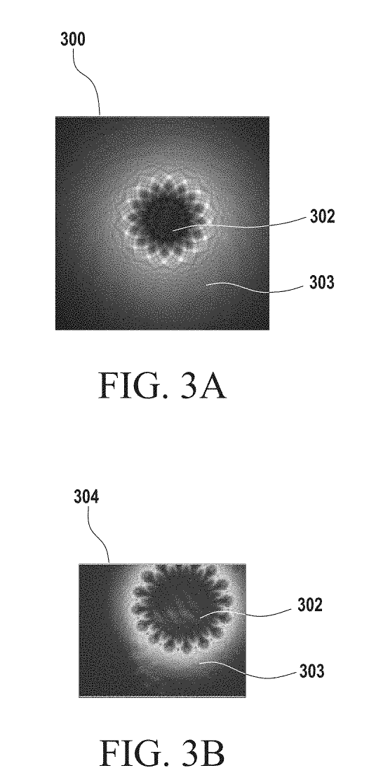

FIG. 3A depicts the coronagraphy testbed sensor gray image 300 using a collimated laser source with the petal mask area 302 and glass substrate fringes 303. FIG. 3B illustrates the coronagraphy testbed sensor colored 304, which is an equivalent image, to illustrate the discrepancy δ problem streaks of light in the shadow of the petal mask area 302 on the sensor that are attributed to fringe interference. The laser light penetrates the flat glass substrate on which a petal mask of a specified diameter (two millimeter) is mounted. The petal mask is the light occulter and its shape is imaged in the optical focal plane on a CCD detector. The ideal petal mask shape image intensity is predicted on the CCD. However, the actual intensity measurement by the detector differs from the predicted by δ due to the fringes caused by the glass substrate. The distance between the occulter mask and the detector determines its influence on interference.

Therefore, there is a need for a technological solution to detect and remove fringe interference in a digital domain, in real time, by using image processing.

As discussed above, an image formed by a collimated laser source through a quartz substrate (i.e., glass) on a charge coupled device (“CCD”) detector is susceptible to interference fringes due to the impurities in the quartz material. However, by applying antireflection coatings on both sides of the quartz material substrate, interference fringes are substantially reduced, but not removed entirely.

Those interference fringes, which are analogous to the Moire Pattern, can be removed statically using image processing after the in-situ measurement or dynamically during observation. It is beneficial to eliminate these patterns using a near-real time processing due to the dynamic and non-linear nature of these interference fringes in 2-D image processing, where the beam source location could change at any angle.

As discussed above, petal masks are mounted on a glass substrate in different mask configurations (number of petals and mask diameter size), which can be an indication of the presence of fringes. These fringes have an effect on the light intensity reduction by the petal mask.

Removing the fringes in a digital domain is accomplished by applying a combination of 2-D EMD and HSA (i.e., HHT2-Fringe), which is designed specifically for analyzing the data from non-linear and non-stationary processes and applying it to the static CCD images imprinted with generic interference fringe patterns.

Furthermore, expanding and enhancing the HHT2-Fringe to dynamically detect and remove fringe patterns in near real-time, namely in time before the next image is acquired.

Interference fringes are removed using HHT2-Fringe, in real-time, using HHT2-based processing software by solving the discrepancy δ problem between between the Iₘ 201 and the Iₚ 202, of the petal mask.

For example, for a function of 1-D, the spectral content is simple for time variable functions. The slightest variability in the function leads to its rich spectral content. Fourier Transformation for 1-D (“FFT1”) is used for 1-D function data spectral analysis. After selecting a few frequencies of interest in FFT1 post-analysis image processing in the frequency domain, the inverse of the FFT1 (IFFT1) on these selected frequencies (with amplitudes of all other frequencies zeroed-out) is applied for the signal constituents of interested synthesis.

For example, application of the Fourier Transformation to a function of 2-D (FFT2 on 2-D), analyses is ubiquitous but with less clarity in image synthesis, because the FFT may not yield results that bear physical meaning because Fourier Theory assumes data linearity and data being stationary which appears to be more restrictive for images greater than 1-D (e.g., 2-D images).

For example, when a photograph is depicted together with the applied Fourier Transform analysis results for phase extraction from the image frequency variability components, the resulting spectral analysis phase (in addition to spectral amplitude) is difficult to interpret.

As discussed above, HHT2-Fringe is a combination of application of EMD2 and HSA2. EMD2 and HSA2 are discussed in the related art.

There is always a presence of an image noise component that has a definitive spectrum attributed to its nature. Fringe pattern phenomenology is of an oscillatory nature and if fringes are visibly present in one area of an image (areas not masked) they are also present throughout the image and in the shadow of the mask, which is the image noise component, even at miniscule amplitudes of intensity, I_{fringes}, defined as:

Iₘ=Iₘₐₛₖ+I_{fringes}+μ (2)

The equation (2) is an empirical definition of the measured light intensity's composition of components attributed to the mask, noise of fringes and some negligible intensity component μ.

Iₘ is the total light intensity under the optical filter mask, Iₘₐₛₖ is the theoretically predicted intensity due to the mask, and μ is negligible variability due to jitter of the object or camera. Iₙₒᵢₛₑ is invariably present in all natural phenomena measurements.

A measurement image Iₘ, as presented in (2), is invariably formed of composite components having different scales of variability and characteristics for an image in the presence of interference fringes.

Image decomposition is the decomposition of an image in order to extract its variability components, which leads to the image spectrum content.

Fast decomposition of experimental images into component images is necessary to distinctively demonstrate the fringe patterns, using the real-time HHT2 in the image analysis phase.

Then, the decomposed images fringe pattern extraction I_{fc} and intermediate images synthesis into resulting image Iᵣ are formed such that at the sensor center vicinity (I_{rc}), the measured light intensity (I_{mc}) satisfies the following inequality:

I_{rc}≦I_{mc}−δ (3), where

δ˜I_{fc} (4)

Processing a large set of images and determining the fringe contribution to the light intensity streaks in the shadow of the optical filter petal masks satisfies this inequality.

For example, for 1-D, use FFT1 and HHT1. FFT is based on a trigonometric functions basis and Euler equations to represent Fourier components in an exponential form for linear and stationary data, to be 1-D or 2-D: eⁱ θ=cos θ+i sin θ.

For 1-D, the HHT1 expands the Euler equation to analytic signal a for an arbitrary real function of one real variable, using the Hilbert Transform for 1-D (“H”) (1905) and Dennis Gabor (1945) formulation of an analytic signal:

a(x)=f(x)+iH(f(x)) or (4)

The analytic signal in (4) can also be expressed in the classical form of amplitude (“A(x)”) and phase (“φ(x)”).

a(x)=A(x)eⁱφ(x)

For 2-D, the HHT2 expands analytic signal representation to represent a monogenic as follows:

z(x,y)=f(x,y)+iH2(f(x,y)) (5)

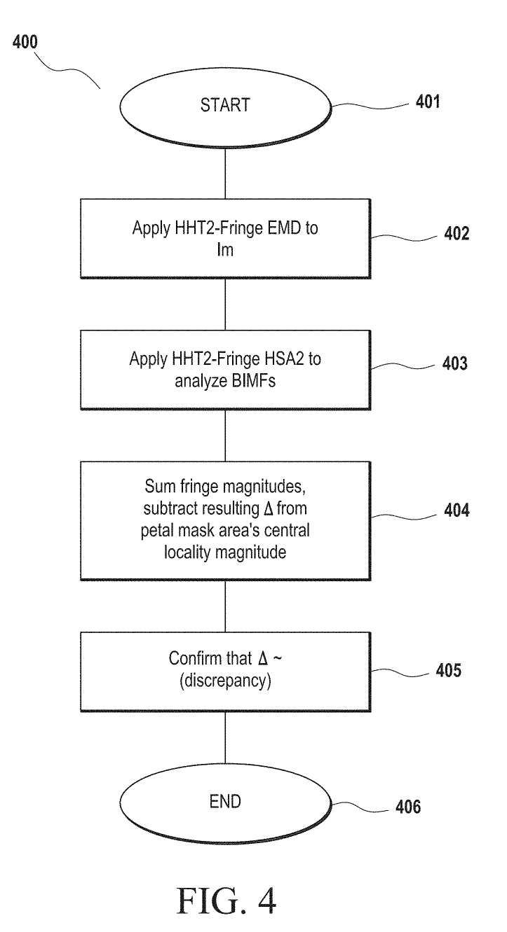

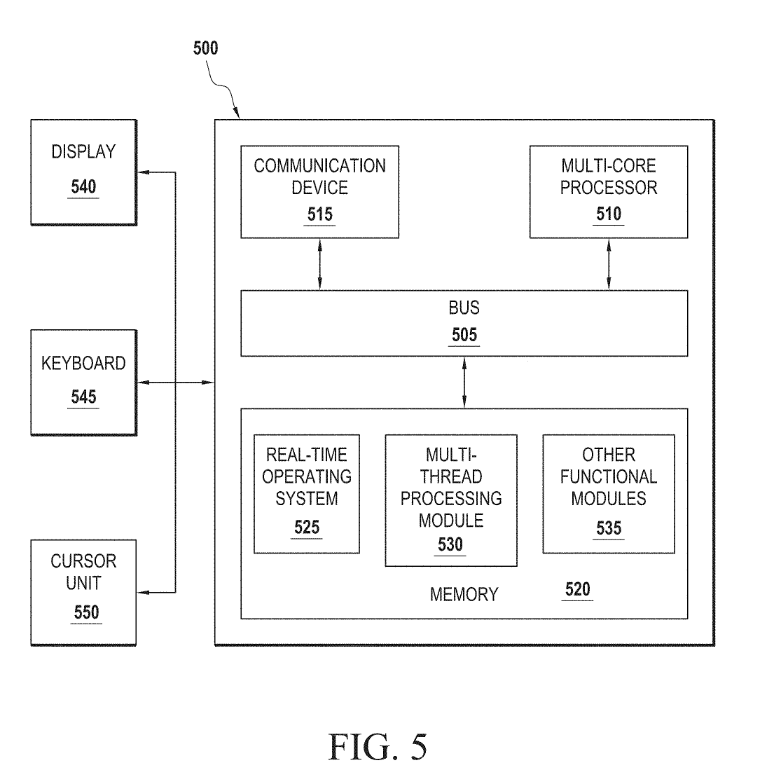

FIG. 4 illustrates HHT2-Fringe method 400 with 2-D capabilities, according to an embodiment of the present invention. The method of FIG. 4 may be executed by, for example, the computing system shown in FIG. 5. This execution may be in real time or near real time.

In order to use the HHT2-Fringe EMD2, the method 400 begins 401 at step 402 which is to apply to HHT2-Fringe EMD2 to Iₘ:

HHT2-Fringe-EMD2(Iₘ)={BIMF₁,BIMF₂, . . . ,BIMFₖ}.

The BIMFs can be used to visualize qualitative behavior of these bases functions (i.e., patterns) caused by its amplitudes quantitative content. However, image features are “better” detected by more stable instantaneous frequency content that can be generated by the HSA2 component of the HHT2-Fringe.

The method 400 continues to step 403 which applies the HHT2-Fringe HSA2 in order to analyze {BIMF₁, BIMF₂, . . . , BIMFₖ}, which are the two outer fringe bright bands.

BIMFᵢ is characterized by stable frequency ring values and the method uses their indices to go back to the BIMFᵢ, by propagating these fringe's amplitudes into the center of the image using linear approximation.

The method 400 continues to step 404 which uses the fringe magnitudes for all BIMFs (calculated in the previous steps), sums them up, and subtracts the resulting Δ from the petal mask area's central locality magnitudes. This reconstructs the intensity's attributes to the mask only and thus mitigates the fringe-based interference.

Finally, the method 400 proceeds to step 405 which confirms the result in (4) is satisfied, i.e.:

Δ˜δ (6)

If the result is satisfied, the method ends 406.

The method steps performed in FIG. 4 may be performed by a computer program, encoding instructions for the nonlinear adaptive processor to perform at least the method described in FIG. 4, according to an embodiment of the present invention. The computer program may be embodied on a computer-readable medium. A computer-readable medium may be, but is not limited to, a hard disk drive, a flash device, a random access memory, a tape, or any other such medium used to store data. The computer program may include encoded instructions for controlling the nonlinear adaptive processor to implement the method described in FIG. 4, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, or an application specific integrated circuit (“ASIC”).

The HHT2-Fringe System is a computer-based system which may be configured with an NVIDIA card providing super-computing capabilities. It hosts a software module, HHT2-Fringe, running in near-real time for analysis of laboratory test images and synthesis, resulting in fringe effects I_{fc} detection and removal. Essentially, an input image with fringe presence was decomposed using HHT2-Fringe.

In another embodiment, for each spectral component, BIMFᵢ that carries pixels with fringes, there are two methods of fringe removal.

The first method occurs when there are pixels with some “dark” and “light” fringe magnitudes along some arbitrarily selected but fixed direction radius vector from the center. In this situation, the gradient drop is calculated and continuation of its propagation into the mask shadow are computed and the Δ_{I} is computed, such that.

I_{fc}=Δ=ΣΔᵢ, for 1<=i<=k (7)

The HSA2 can further be used to detect the fringe patterns to narrow the accuracy of Δ.

The second method is the direct computation of the intensities in BIMFᵢ under the mask shadow, which can be computed because only the fringes have a spectral component revealed by the BIMFᵢ (in the outer BIMFs). The first method uses the BIMFs amplitudes gradient and the second method further refines the solution by analysis of the BIMFs' spectrum using the HSA2.

FIG. 5 illustrates a block diagram of a real-time data processing system 500 with 2-D capabilities, according to an embodiment of the present invention. System 500 may include a bus 505 or other communication mechanism that can communicate information and a processor 510, coupled to bus 505 that can process information. Processor 510 can be any type of general or specific purpose processor. System 500 may also include memory 520 that can store information and instructions to be executed by processor 510. Memory 520 can be comprised of any combination of random access memory (“RAM”), read only memory (“ROM”), static storage such as a magnetic or optical disk, or any other type of computer-readable medium. System 500 may also include a communication device 515, such as a network interface card, that may provide access to a network.

The computer-readable medium may be any available media that can be accessed by processor 510. The computer-readable medium may include both volatile and nonvolatile medium, removable and non-removable media, and communication media. The communication media may include computer-readable instructions, data structures, program modules, or other data and may include any information delivery media.

Processor 510 can also be coupled via bus 505 to a display 540, such as a Liquid Crystal Display (“LCD”). Display 540 may display information to the user. A keyboard 545 and a cursor control unit 550, such as a computer mouse, may also be coupled to bus 505 to enable the user to interface with system 500.

According to one embodiment, memory 520 may store software modules that may provide functionality when executed by processor 510. The modules can include an operating system 525 and a processing module 530, as well as other functional modules 535. Operating system 525 may provide operating system functionality for system 500. Because system 500 may be part of a larger system, system 500 may include one or more additional functional modules 535 to include the additional functionality.

It should be apparent from the foregoing description that various exemplary embodiments of the invention may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A non-transitory machine-readable storage medium may include any mechanism for storing information in a form readable by a machine, such as a personal or laptop computer, a server, or other computing device. Thus, a non-transitory machine-readable storage medium may include read-only memory (ROM), random-access memory (RAM), magnetic disk storage media, optical storage media, flash-memory devices, and similar storage media and excludes transitory signals.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Accordingly, it is to be understood that the above description is intended to be illustrative and not restrictive. Many embodiments and applications other than the examples provided would be apparent upon reading the above description. The scope should be determined, not with reference to the above description or Abstract below, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for fringe detection and mitigation in an image using Hilbert-Huang Transform (“HHT2-Fringe”), the method comprising:
applying Empirical Mode Decomposition (“EMD2”) to a measured light intensity suppression of the image to generate bi-dimensional intrinsic mode functions (“BIMFs”);
applying Hilbert Spectral Analysis (“HSA2”) to analyze a plurality of outer fringe bright bands of the BIMFs;
propagating the amplitudes of the plurality of outer fringe bright bands of the BIMFs into the center of the image using linear approximation; and
determining fringe magnitudes of the BIMFs, adding the magnitudes of the BIMFs, and subtracting the difference from magnitudes of a petal area of the image.

2. The method of claim 1, further comprising:
determining whether the difference between the magnitudes of the BIMFs and the magnitudes of the petal area of the image is approximately the difference between the measured light intensity suppression and a predicted light intensity suppression.

3. The method of claim 1, wherein BIMFs visualize qualitative behavior of base functions caused by amplitude quantitative content.

4. A non-transitory computer readable medium storing program code for fringe detection and mitigation in an image using Hilbert-Huang Transform (“HHT2-Fringe”), the program code being executable by a process to perform operations comprising:
applying Empirical Mode Decomposition (“EMD2”) to a measured light intensity suppression of the image to generate bi-dimensional intrinsic mode functions (“BIMFs”);
applying Hilbert Spectral Analysis (“HSA2”) to analyze a plurality of outer fringe bright bands of the BIMFs;
propagating the amplitudes of the plurality of outer fringe bright bands of the BIMFs into the center of the image using linear approximation, and
determining fringe magnitudes of the BIMFs, adding the magnitudes of the BIMFs and subtracting the difference from magnitudes of a petal area of the image.

5. The non-transitory computer readable medium of claim 4, further comprising:
determining whether the difference between the magnitudes of the BIMFs and the magnitudes of the petal area of the image is approximately the difference between the measured light intensity suppression and a predicted light intensity suppression.

6. The non-transitory computer readable medium of claim 4, wherein BIMFs visualize qualitative behavior of base functions caused by amplitude quantitative content.

7. A computing device for fringe detection and mitigation in an image using Hilbert-Huang Transform (“HHT2-Fringe”) comprising:
a processor, and
a memory coupled to the processor and containing instructions that, when executed by the processor, perform a set of functions including:
applying Empirical Mode Decomposition (“EMD2”) to a measured light intensity suppression of the image to generate bi-dimensional intrinsic mode functions (“BIMFs”);
applying Hilbert Spectral Analysis (“HSA2”) to analyze a plurality of outer fringe bright bands of the BIMFs;
propagating the amplitudes of the plurality of outer fringe bright bands of the BIMFs into the center of the image using linear approximation, and
determining fringe magnitudes of the BIMFs, adding the magnitudes of the BIMFs and subtracting the difference from magnitudes of a petal area of the image.

8. The computing device of claim 7, the memory further comprising instructions, that when executed by the processor perform a set of functions including:
determining whether the difference between the magnitudes of the BIMFs and the magnitudes of the petal area of the image is approximately the difference between the measured light intensity suppression and a predicted light intensity suppression.

9. The computing device of claim 7, wherein BIMFs visualize qualitative behavior of base functions caused by amplitude quantitative content.
